(19) United States
(12) Patent Application Publication
(10) Pub. No.: US 2024/0101489 A1
(43) Pub. Date: Mar. 28, 2024

(54) METHODS AND COMPOSITIONS FOR IMPROVING PLANT GROWTH

(71) Applicant: NUtech Ventures, Lincoln, NE (US)

(72) Inventors: Arindam Malakar, Lincoln, NE (US); Daniel Snow, Lincoln, NE (US); Chittaranjan Ray, Lincoln, NE (US)

(21) Appl. No.: 18/368,904

(22) Filed: Sep. 15, 2023

Related U.S. Application Data
(60) Provisional application No. 63/376,002, filed on Sep. 16, 2022.

(51) Int. Cl. C05D 9/00; A01C 1/06

(52) U.S. Cl. CPC C05D 9/00; A01C 1/06

(57) ABSTRACT

The present disclosure describes compositions that include ferrihydrite (Fh) and methods of using such compositions to improve the growth of plants.

### CROSS REFERENCE TO RELATED APPLICATIONS

This application claims the benefit of priority under 35 U.S.C. § 119(e) to U.S. Application No. 63/376,002 filed Sep. 16, 2022.

### FEDERALLY SPONSORED RESEARCH OR DEVELOPMENT

This invention was made with government support under NI19HMFPXXXXG032, NI17HFPXXXXXG047, NI17HMFPXXXXG026, NI18HMFPXXXXG022, and NI20HMFPXXXXG023 awarded by the National Institute of Food and Agriculture. The government has certain rights in the invention.

### TECHNICAL FIELD

This disclosure generally relates to methods and compositions for improving plant growth.

### BACKGROUND

The topsoil in large areas of the Corn Belt in the United States contains significant quantities of naturally-occurring arsenic (As) and uranium (U). Plants grown in soil with elevated concentrations of these trace elements may be prone to bioaccumulation, which may impact human health. Therefore, it is necessary to understand their bioavailability in unsaturated agricultural soils and devise plans to mitigate their occurrence in agricultural products. Iron is an essential nutrient for crops, and uptake by reduction or chelation can influence iron geochemistry in the soil. Understanding these relationships can be important for improving plant growth and assisting in nutrient management.

### SUMMARY

Provided herein are compositions that include ferrihydrite (Fh) and methods of using such compositions to improve the growth of plants.

In one aspect, methods of improving the growth of plants are provided. Such methods typically include applying a composition to seeds, to the plants, or to soil in which the plants are growing, wherein the composition comprises ferrihydrite (Fh) or a pharmaceutically acceptable salt thereof.

In some embodiments, the composition is a powder. In some embodiments, the composition is a liquid. In some embodiments, the composition is diluted prior to the applying step. In some embodiments, the composition has a pH of about 6.5. In some embodiments, the composition further comprises a zinc compound or other macronutrients and/or micronutrients.

In some embodiments, the applying is via irrigation systems. In some embodiments, the applying is via a spray. In some embodiments, the applying is via coating seeds. In some embodiments, the applying occurs more than once in a growing season. In some embodiments, soil and/or crop iron levels are monitored.

In some embodiments, the Fh is applied at an amount ranging from 0.02% w/w to 0.15% w/w.

In some embodiments, improving growth refers to increasing water retention, improving water availability for plants in arid to semi-arid conditions, and/or reducing water loss under both irrigated and dryland agricultural soil. In some embodiments, improving growth refers to increasing nitrate retention, improving nitrate availability for plants between fertilizations, improving phosphate and other macro- and micronutrients availability for plants and/or reducing nitrate leaching, thereby reducing environmental damage. In some embodiments, improving growth refers to reducing heavy metal bioavailability and/or reducing the bioavailability of uranium and arsenic in plants. In some embodiments, improving growth refers to reducing heavy metal mobility and/or reducing the leaching of uranium and arsenic to the ground water.

In some embodiments, after the applying step, the plants exhibit increased biomass, increased root growth, increased plant height, increased relative chlorophyll content, proper vegetative state even under acute drought conditions, and/or improved carbon sequestration post-harvest. In some embodiments, after the applying step, the plants exhibit lower concentrations of arsenic and uranium and any other geogenic contaminants such as selenium in the (above-ground parts of the) plant and/or increased concentrations of iron in the plant, which can be beneficial to fulfill the iron requirements of humans.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1A-1B are graphs that show changes in the concentration of reduced iron (iron (II); Fe²⁺), total iron, arsenic, percentage (%) of arsenate (oxidized form of arsenic), and uranium (FIG. 1A) and in the concentration of dissolved organic carbon (DOC), orthophosphate, ammonia, nitrite, and nitrate (FIG. 1B) in the soil porewater after 30, 60 and 90 days of sowing seeds. At Day 60, localized reducing conditions were prevalent as observed from lower percentage of arsenate and higher concentration of iron (II). Increasing DOC likely influences soil redox processes and nutrient mobility. “a”, “b” and “c” on top of data points shows significantly different concentration at p<0.01 as per post hoc Tukey test.

FIG. 2 is a graph showing the dry biomass of crops in the presence of the indicated amounts of ferrihydrite (Fh).

FIG. 3A-3E are photographs showing corn grown in the presence of 0.00% w/w Fh-(FIG. 3A), 0.05% w/w Fh—(FIG. 3B), and 0.10% w/w Fh-enriched soil (FIG. 3C), and the roots of corresponding crops at day 45 (FIG. 3D) and day 90 (FIG. 3E).

FIG. 4A-4B are graphs showing relative chlorophyll content (FIG. 4A) and plant height (FIG. 4B). (mean±standard deviation)

FIG. 5 is a graph showing the concentration of iron in plant tissues—root, shoot at midpoint (day 45) harvest and root, shoot, and grains at endpoint (day 90) harvest.

FIG. 6A-6B are graphs showing the arsenic (FIG. 6A) and uranium (FIG. 6B) concentration in root, shoot, and grain in the crops harvested at the mid and endpoint of the experiment. FIGS. 6A and 6B show significantly different concentration at p<0.01 as per post hoc test by Tukey's method. Bars without letters means interactions were non-significant.

FIG. 7A-7D are graphs showing grain to shoot arsenic and uranium concentration within the crops (FIG. 7A), shoot to root arsenic (FIG. 7B), shoot to root uranium ratio (FIG. 7C), and percentage (%) of total arsenic and uranium (FIG. 7D) in grains and roots of crops at the endpoint of the experiment in three Fh enriched systems.

FIG. 8A-8B are graphs showing the concentration of dithionite-citrate-bicarbonate (DCB)-extractable iron (FIG. 8A) and soil nitrate (FIG. 8B) among the three different Fh amended systems, at the rhizosphere soil and bulk soil for mid (Day 45) and endpoint (Day 105) of the experiment. Elevated levels of Fh at the root zone are associated with higher iron uptake by crops and corresponds to a reduction in the available (DCB extractable) iron concentration at the root zone soil in Fh amended systems at the completion of the experiment. Fh amendment correlates to elevated levels of soil nitrate at the root zone, likely increasing available soil nitrogen as nitrate to the plant. ** above vinculum (represent comparison between, root and bulk soil within same system); FIGS. 8A and 8B show significantly different concentrations between the treatments at p<0.01 as per post hoc Tukey test. Bars without letter means interactions were not significant.

FIG. 9A-9B show soil moisture content (FIG. 9A) at 15 cm depth measured by handheld moisture probe or gravimetric moisture content (FIG. 9B) measured biweekly. Probe moisture measurements correlate to laboratory gravimetric moisture contents and addition of Fh appears to provide increased soil water holding capacity compared to control.

FIG. 10 shows the predicted role of iron nanominerals or ferrihydrite (Fh (red)) enrichment at the root zone soil. This increase in bioavailable iron enhances crop iron uptake, primarily by chelation. Elevated levels of iron at the root zone-soil-porewater interface intensifies root zone processes (green arrow) such as release of exudates for chelation, which may further drive the preferential enrichment of Fh nanomineral to the interface of root zone (red arrows). The directed flow elevates levels of Fh in the root zone, also makes nutrients (blue dots) such as nitrate (added on day 7 after Fh amendment), concentrated at the vicinity of roots, enhancing plant biomass, and health indices. The addition of Fh nanomineral limits movement of trace contaminants (yellow dots) such as naturally occurring arsenic and uranium from soil and irrigation water, while retaining nutrients and moisture for crop growth.

FIG. 11 is a graph showing total phosphorus concentration among the three different rates of Fh amendments at the root zone soil and bulk soil at mid (day 45) and endpoint (day 90) of the experiment.

FIG. 12 is a graph showing arsenic content in rice grains, which were grown with and without soil nanoamendment (Fh).

FIG. 13A-13B shows root picture of control (FIG. 13A), 0.07% w/w ferrihydrite-treated soil (FIG. 13B), along with arsenic speciation chromatogram of the irrigation water collected on the day of soil sampling. Initial irrigation water contained only arsenate (As (V)).

FIG. 14 shows 2023 field trials in eastern Nebraska, where rainfed (dryland) and sprinkler (center-pivot) sites are being investigated under corn. The numbered plots, 1 to 6 received Fh at 0.05% w/w.

### DETAILED DESCRIPTION

Iron (III) oxyhydroxide nanominerals, occur naturally in soils, sediments, surface water, and groundwater, but the crystalline forms are difficult to identify. The nano-size of these iron minerals results in its high specific surface area and can sequester significant quantities of trace elements, nutrients and increase water holding capacity. The occurrence and crystalline transformation of these iron oxyhydroxide nanominerals is largely dependent on the environment and is controlled by pH, temperature, ionic strength, and organic matter. These natural transformation of iron nanominerals, such as ferrihydrite (Fh), can occur within days to months under anoxic conditions but is slow under oxic conditions at near-neutral pH, and can take months to years to show any mineralogical changes. Anoxic conditions are prevalent in flooded irrigation, as in rice production, whereas oxic conditions are relevant for non-flooded irrigated agricultural unsaturated soil, which comprises 55% of total irrigated area of the US. Thus, under unsaturated conditions prevalent in sprinkler, drip or furrow irrigation, iron nanomineral transformation will occur slowly and may be limited within anoxic microsites of the unsaturated zone. These nanominerals should sustain for prolonged period and can be beneficial to enhance water holding capacity, nutrient use efficiency and retention, limit trace element mobilization, aid in crop growth, and improve below ground biomass, thereby sequestering carbon in soils. These experiments show that addition of a specific form of iron nanomineral provides agronomic benefits, while reducing uptake of contaminants that may impact food quality.

In the current agroecosystem, it is predicted that plants only use 42-47% of applied nitrogen fertilizer, and similar losses of phosphorus and potassium fertilizer also are reported. Further, the continuous agricultural practices have diminished soil carbon content, making it less yielding. Similar observations echo in recent interviews conducted among farmers. We found that close to 92% of interviewees agree that 50% or more of applied fertilizer, specifically, nitrogen fertilizer, is lost. Farmers, who were the primary group in the interviews, mentioned that fertilizer cost is the largest cost in their operation and any new product trial depends largely on return on investment. Farmers also preferred direct application via seed to minimize associated costs. Moreover, 96% of farmers mentioned they would try a product supported by peer-review data. The soil nanoamendment technology proposed here can help crop growers (particularly irrigated crops) reduce nitrogen, phosphorus, and/or potassium application rates by improving their fertilizer use efficiency between 30%-50% and, at present cost, saving $80 to $140/ac, while improving their soil carbon sequestration (˜10-25%) and reducing their water usage (˜5-10%). These additional benefits such as carbon sequestration and water usage can add up to a $10-$40/ac savings for producers. If only irrigated acres are targeted in the state of Nebraska alone (5.2 million acres), this adds up to ˜$5.5 billion savings/yr. Additionally, under dryland irrigation, the added soil moisture retention can promote crop growth during acute drought conditions.

As described herein, Fh applied in pure form or as an iron salt can be used to improve the growth of plants relative to corresponding plants grown under the same conditions in the absence of Fh. In particular, Fh can be used to increase water retention, improve water availability for plants in arid to semi-arid conditions, reduce water leaching, increase nitrate retention, and improve nitrate availability for plants between fertilizations. Addition of Fh to irrigated soils may also reduce soil nitrate leaching losses, reduce mobility, bioavailability and uptake of contaminants such as uranium and arsenic in plants. Results suggest that the addition of Fh may also reduce the leaching losses of natural uranium and arsenic to the ground water, and improve crop growth and soil carbon sequestration.

Arsenic can be present as arsenite or arsenate (As(III/V)) oxyanion, and mobilization is sensitive to the redox conditions and pH of soil or water. The reduced form of arsenic is more mobile, whereas for uranium, the oxidized cation (uranyl ion: U(VI)O₂²⁺) is mobile, and U(IV), the reduced form, is considered immobile. In unsaturated soil, the oxidized forms of arsenic and uranium are more prevalent, and various biogeochemical processes of unsaturated soils can influence the bioavailability of these contaminants. Interactions with iron oxides/hydroxides affect many trace contaminants and nutrients mobility and bioavailability.

The experiments show that addition of Fh to soil resulted in increased plant biomass, root growth, plant height, relative chlorophyll content, and appropriate (for the particular crop) growth stage under drought-like conditions, relative to corresponding plants grown under the same conditions in the absence of Fh. Similarly, plants grown in soils receiving Fh exhibited lower concentrations of arsenic and uranium in the above-ground parts of the plant, and increased concentrations of iron in the plant, relative to corresponding plants grown under the same conditions in the absence of Fh.

A composition that includes Fh can be provided in the form of a liquid, applied via irrigation systems, applied directly to the plants or coated on seeds, and produced at large-scale in the point-of-use system by the end-user. In some instances, the liquid composition may require dilution before being applied to the plants. Alternatively, a composition that includes Fh can be provided as a powder, which can be dissolved in a liquid (e.g., water) before being applied to the plants. In some instances, the composition has a pH of about 6.5 or is adjusted to a pH of about 6.5, and, in some instances, the composition further includes a zinc compound (e.g., zinc acetate), which can provide additional zinc requirements to the crops.

In the field, a composition including Fh can be applied via an irrigation system or via a spray. The soil nanoamendment can be produced in the field and also can be coated on the seeds before planting. A composition including Fh can be applied to the plants once per growing season or more than once per growing season (e.g., twice per growing season, three times per growing season, monthly, weekly, etc.), and a composition including Fh can be applied at an amount ranging from 0.02% ww/w to 0.15% w/w, which can be adjusted based on the naturally occurring Fh in the field. The wide range can be maintained during application via seed coating.

Here, we show that adding Fh to the rhizosphere of unsaturated or saturated agricultural soil can limit arsenic and uranium bioavailability, enhance soil nutrient retention and promote crop productivity. As described herein, Fh's essential role was demonstrated through increased plant biomass, improved nutrient availability and decreases in trace element plant uptake.

In accordance with the present invention, there may be employed molecular biology, microbiology, biochemical, and recombinant DNA techniques within the skill of the art. Such techniques are explained fully in the literature. The invention will be further described in the following examples, which do not limit the scope of the methods and compositions of matter described in the claims.

### EXAMPLES

### Example 1—Materials

Reagents, including iron (III) chloride (FeCl₃) reagent grade (97%) or iron (III) nitrate (Fe(NO₃)₃) or any iron (II) or iron (III) water-soluble salt or hydrated salt, sodium bicarbonate (ACS reagent, >99.7%, NaHCO₃), trisodium citrate dihydrate (ACS reagent, 99%), ferrous sulfate (99.9%), ammonium acetate (99.9%), acetic acid (99.9%), calcium carbonate (ACS reagent, 99%), sodium nitrite (ReagentPlus®, >99.0%), and 1,10-phenanthroline (99.9%) were purchased from Sigma-Aldrich, USA. Sulfanilamide (Certified ACS, Fisher Chemical), N-(1-Naphthyl)ethylenediamine, dihydrochloride (98+%, ACS reagent), zinc acetate dihydrate (Zn(CH₃COO)₂·2H₂O) (extra pure, 98%), ammonium carbonate (ACS reagent, (NH₄)₂CO₃), sodium hydrosulfite (ca. 85%, Tech., Na₂S2O₄), and potassium hydroxide (KOH) were manufactured by ACROS Organics™ and purchased from Fisher Scientific, USA. Arsenic and uranium standards were purchased from Inorganic™ Venture, USA. Arsenite (As(III)) and Arsenate (As(V)) reference standards were purchased from Millipore Sigma, USA. All water used in the experiment was reagent grade with a resistivity of 18.2 MΩ-cm.

### Example 2—Synthesis of 2-Line Ferrihydrite

The target iron nanomineral is ferrihydrite (Fh). Fh synthesis was carried out following method described elsewhere (Islam et al., 2020, Environ. Sci. Water Res. Technol., 6:2057-64; Malakar et al., 2020, Environ. Sci. Technol., 54:13839-48). Briefly, 25 g of FeCl₃ salt was dissolved in 10 L of reagent-grade water or tap water. The pH of this solution mixture was brought to near neutral by controlled addition of KOH, and pH was kept around ˜6.5±0.2. It has been observed that a pH above 4 is needed to precipitate Fh. Finally, 0.15 g of Zn(CH₃COO)₂·2H₂O or water-soluble acetate salt was added to change the zeta potential of the solution. The whole mixture was shaken well to precipitate 2-line Fh (also called hydrous ferric oxides (HFO)). The solution was decanted to reduce volume and filtered. The precipitate was dried in a vacuum desiccator for 48 hours before use. Multiple batches of synthesis were carried out to produce all of the 2-line Fh required for the greenhouse experiment. Powder XRD (PANalytical Empyrean Diffractometer, Cu K_{α} source) was carried out to confirm formation of 2-line Fh, which matches well to the (110) and (115) planes of 2-line Fh (PCPDF #29-0712) (Islam et al., 2020, Environ. Sci. Water Res. Technol., 6:2057-64; Zhu et al., 2015, RSC Adv., 5:84389-97). This method can be easily scaled up to make larger quantities of the soil amendment.

### Example 3—Greenhouse Experiment

The greenhouse experiment was modified from Malakar et al. (2020, Environ. Sci. Technol., 54:13839-48). Eight kilograms of soil collected from Scottsbluff, NE was weighed out in 18 pots of 25 cm diameter. The soil classified as Tripp is a very fine sandy loam soil (coarse-silty, mixed, superactive, mesic Aridic Haplustolls) and was collected within a 10 m by 10 m by 10 cm (depth) grid. The field had been planted to maize in the previous growing season. The average precipitation at Scottsbluff is 401 mm and average snowfall is 109.2 cm, in summer the average high temperature is 33.4° C. and in winter average low temperature is −9.9° C. The soil was air-dried in a greenhouse and sieved through 2 mm mesh, before the start of the experiment. Air-dried soil pH was 7.5±0.1 and soil organic matter content was 18±2 g kg⁻¹. The residual nitrate and ammonia concentrations of the air-dried soil were at 2.3±0.6 μg-N g⁻¹, and 0.7±0.2 μg-N g⁻¹, respectively. Agricultural soil contained arsenic (2.9±0.4 μg g⁻¹), and uranium (1.1±0.2 μg g⁻¹), which are of geogenic origin.

Eight kilograms of air-dried soil were weighed out in each polyethylene planting pots (n=18) of 25 cm diameter. The eighteen pots were divided into three groups. One set of six received no Fh (Control=0.00% w/w, n=6). Another set of six received 0.05% w/w Fh, (n=6), and the final set received 0.10% w/w Fh (n=6) as a soil amendment. Fh was applied by dispersing in 50 g of reagent grade water and mixed in the top 5 cm of the soil layer. The top 5 cm soils of control pots were mixed only with 50 g of reagent grade water. Three maize seeds (cultivar-Dekalb®, DKC46-36RIB Brand Blend) were added to each pot, and thinned to one plant after germination. Maize was grown for 105 days and had formed grains (kernels) by the end of the experiment. Replicates of different Fh application rates were randomly distributed in the greenhouse at the University of Nebraska-Lincoln (UNL).

Greenhouse temperature was controlled between 22-28° C. and crops received 16 h of daily light. Artificial irrigation water containing elevated concentration of arsenic (48.8±2.0 μg L⁻¹) and uranium (49.8±0.9 μg L⁻¹) was prepared utilizing arsenic and uranium standard solution; the pH of irrigation water was around −6.9±0.1. Higher concentration of arsenic and uranium was chosen to see the impact of elevated arsenic and uranium concentration on plant uptake of trace contaminants. Instead of fertilizer, modified Hoagland solution (Hoagland & Arnon, 1950, California Agricultural Experiment Station, 347) was utilized to supply macro and micro-nutrient required for the crop growth. As iron is typically provided by soil-borne sources, the prepared Hoagland solution was devoid of iron and phosphate, which is generally not used as fertilizer in the field from where soil was collected. Hoagland solution was applied on day 7 after adding seeds to the pots and 100 g was added on day 31 and 61, right after each pore water collection, to replenish essential nutrient required for sustaining crop growth as per crop demand.

Equal weight of irrigation water was given to each crop, every other week from day 21, after Hoagland solution application. Moisture content in the top 15 cm was measured using a handheld moisture probe twice a week (Extech M0750 Soil Moisture Meter, FLIR Commercial Systems Inc., Nashua, NH, USA) (Deng et al., 2015, PLoS One, 10), and gravimetrically every other week. Water application was controlled after porewater sampling events, and further water application was not needed to maintain unsaturated conditions. Soil field capacity was measured for the soil before the start of the experiment. Porewater from each pot was collected as leachate in a clean tray placed at the bottom of the pot after 30, 60, and 90 days of sowing seeds. Equal weight (1500 g) of artificial irrigation water was added to each pot and, within 30 minutes, leachate were collected in tray. Health indices of crops were measured prior to porewater and soil collections for chlorophyll content, which was assessed with a chlorophyll meter (SPAD-502, Minolta, Tokyo, Japan) by averaging five readings of the tallest fully collared leaf (Zhang et al., 2009, Commun. Soil Sci. Plant nal., 40:2087-93). Plant height was measured from the soil surface to the arch of the uppermost leaf (Freeman et al., 2007, Agron. J., 99:530-6).

### Example 4—Porewater, Soil, and Plant Tissue Analyses

Collected porewater samples were filtered using 0.45 μm syringe filter and sub-sampled. Given the size range of added Fh (Michel et al., 2007, Material Science, 316:1726-9) and organic-iron complexes (Ritter et al., 2006, Environ. Sci. Technol., 40:5380-7) formed in the rhizosphere, chances of including colloidal iron in filtered porewater are high but may be considered to be part of the dissolved iron phase. Porewater samples were analyzed in situ within 10 mins of collection for reduced iron (Fe²⁺), and nitrite spectrophotometrically (Kaifer, 1992, J. Chem. Educ., A305; Oliveira et al, 2006, J. Food Sci., 69:C690-C695; Tamura et al., 1974, Talanta, 21:314-8; Zhu et al., 2018, Appl. Water Sci. 8). Within 48 hours, unpreserved sub-samples were used to measure alkalinity, dissolved organic carbon (DOC), major anions, and inorganic arsenic species (Kutscher et al., 2012, Thermo Scientific No. 43099; Yu et al., 2019, Molecules, 24). Subsamples for nitrate, and ammonium were preserved with sulfuric acid, whereas hydrochloric acid was used to preserve arsenic, uranium, total iron, major cations subsamples. Porewater arsenic and uranium concentration reported here has been deducted from the concentration present in irrigation water, which were 48.8±2.0 μg L⁻¹ and 49.8±0.9 μg L⁻¹ for arsenic and uranium, respectively.

Soil pH (Oakton PHTestrs 30), by 1:1 soil:water solution, and oxidation-reduction potential (ORP) (Oakton ORPTestr 50), at 5 cm depth, were measured bi-weekly. Soil samples from each pot were collected at Day 0, midpoint (Day 45), and endpoint (Day 105). Air-dried soil samples were analyzed for dithionite-citrate-bicarbonate (DCB) extractable iron (Colombo et al., 2014, J. Soils Sediments, 14:538-48), acid-leachable iron, arsenic, and uranium by inductively coupled plasma mass spectrometry (Thermo Dionex IC 5000+ iCAP RQ, ICP MS). Mid (Day 45) and endpoint (Day 105) soils with visible roots were collected as root zone or rhizosphere soil samples, and soil near the edge of the pot with no visible roots was collected as bulk soil samples.

The first group of plant samples (n=3) were harvested at midpoint (Day 45), and the final harvest (n=3) was at endpoint (Day 105). Crop samples were washed with reagent grade water and dried in an oven at 65° C. to constant weight. Plant dry biomass weight was recorded, roots shoots and grains/kernels (wherever available) were separated and quantified by ICP-MS. The bioaccumulation factor (BF) of trace elements in plants and the transfer factors (TEs) from root to shoot and shoot to kernel, were calculated to determine the degree of metal accumulation in the plants (Yashim et al., 2014, J. Appl. Chem., 1-5), following equation,

$$B F = \begin{matrix}Concentration of trace elements in plants \\ \text{?} \\ Concentration of trace elements in soil\end{matrix} ;$$

$$T F = \frac{Concentration of trace elements in plant shoot or kernel}{Concentration of trace elements in plant root or shoot} .$$

$$\text{?} \text{indicates text missing or illegible when filed}$$

Detailed porewater, soil and plant tissue analysis methods are available in the supporting information.

### Example 5—Chemical Equilibrium Modeling

The equilibrium model was carried out by adopting the USGS chemical thermodynamics program PHREEQC (version 3) (Parkhurst & Appelo, 2013, Model. Tech. B., 6:497). The computer program PHREEQC is designed in C language platform and is capable to simulate low-temperature geochemical calculations. The chemical equilibrium is achieved by an ion-association aqueous model and can predict speciation and saturation-indices, which can be implemented in wide variety of reversible and irreversible reactions, which include aqueous, mineral, gas and solid-solution reactions. However, the model is based upon Debye-Hückel expressions to account for the non-ideality of aqueous solutions, which is adequate at low ionic strength but may break down at higher ionic strengths (in the range of seawater and above) (Parkhurst & Appelo, 2013, Model. Tech. B., 6:497). With PHREEQC, species, reactions, and equilibrium constants are all defined in a “database” file. The database wateq4f.dat, derived from WATEQ4F (Ball & Nordstrom, 1991, Open File Report 91-183) was adopted to calculate the different species of the elements analyzed. This database includes relevant uranium, arsenic, and iron species. The model utilized nitrate/ammonium couple to calculate redox-sensitive species (Kolling, 2000, Redox, Springer Berlin Heidelberg, pp. 42-54; Nordstrom et al., 1979, Chemical Modeling in Aqueous Systems, Am. Chem. Soc., pp. 857-92) and predicted equilibrium concentration of reduced iron and arsenic species in the porewater. The model-predicted values of reduced iron and As(V) were compared with experimental results to validate the model. Model inputs included measured temperature, pH, alkalinity, anions, cations, ammonia, total iron, arsenic and uranium (Malakar et al., 2020, Environ. Sci. Technol., 54:13839-48; Nordstrom et al., 1979, Chemical Modeling in Aqueous Systems, Am. Chem. Soc., pp. 857-92).

### Example 6—Statistical Analyses

Statistical analysis was carried out in Origin Pro, Version 2020b (OriginLab Corporation, USA). Data shown herein is presented as mean±standard deviation, error bars in figures are standard deviation. Data were tested for normal distribution and homogeneity of variance. Pearson correlation coefficients and one-way ANOVA analysis with post hoc Tukey test were performed to statistically analyze significant effects of the factor soil Fh amendment (0.00%, 0.05%, and 0.10% Fh) on selected parameters.

Example 7—Iron Redox Cycles, Trace Contaminant Mobility, and Soil Nutrient Retention The irrigation schedule was similar to a typical crop production schedule in the Midwest US (Bowman et al., 1991, J. Irrig. Drain. Eng.; Irmak et al., 2000, Agron. J.). The gravimetric water content was maintained at 15.1±2.5% in all three soil Fh-systems (i.e. 0.00% Fh, 0.05% Fh, 0.10% Fh). In the untreated air-dried soil, DCB extractable iron was 614±56 μg g⁻¹, acid-leachable iron was 9980±588 μg g⁻¹, arsenic was 2.9±0.4 μg g⁻¹, and uranium was 1.1±0.2 μg g⁻¹. From Day 0 to 105, the soil pH was 7.4±0.4, and Eh ORP of bulk soil measured at −5 cm depth varied from 0.38 to 0.47 V, consistent with suboxic to oxic conditions in the bulk soil. Development of localized anoxic microsites within the rhizosphere is a gradual process and depends on the sufficient root and plant growth, so sufficient periods was given before porewater sampling (i.e., 30-90 days).

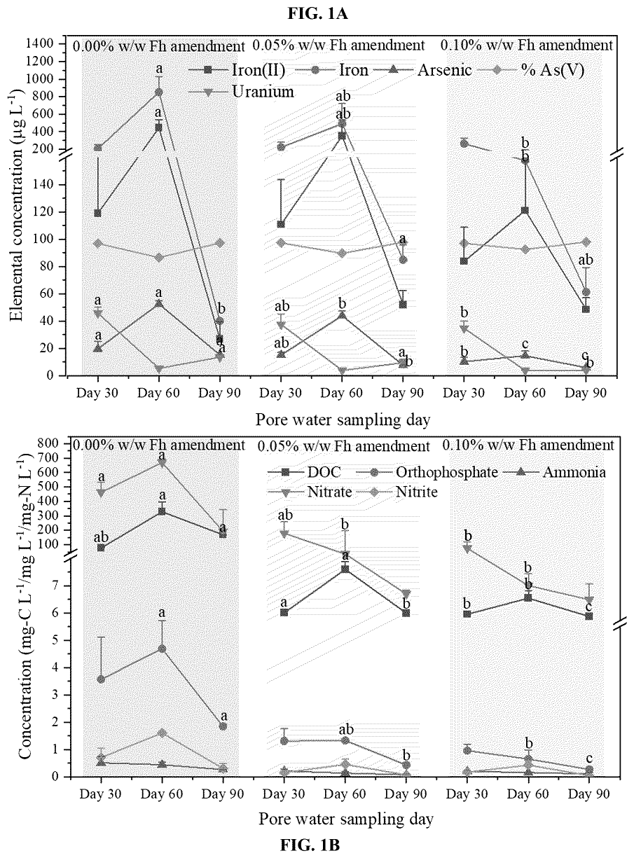

Porewater sampled from all three Fh systems contained reduced iron (Fe′) (FIG. 1A). Cumulative Fe²⁺ concentration (sum of the average concentrations measured at Day 30 (n=6), and at Days 60 and 90 (n=3)) was 588.4 μg l⁻¹ for 0.00% Fh, 514.2 μg l⁻¹ for 0.05% Fh, and 253.0 μg l⁻¹ for 0.10%. The Fe²⁺ concentrations were similar in all three Fh-systems at the first sampling point. Porewater Fe²⁺ was highest at Day 60 and decreased back at Day 90, suggesting dynamic iron redox cycles within the growing period of maize. Though the trend of Fe²⁺ concentration was similar in all three Fh-systems, the Fe²⁺ concentration at Day 60 significantly (p<0.01) differed between these systems. The prevalence of Fe²⁺ in the porewater was unexpected, as maize primarily takes up iron by chelation but Fe²⁺ has been observed in previous studies (Malakar et al., 2020, Environ. Sci. Technol., 54:13839-48; Morrissey et al., 2009, Chem. Rev., 109:4553-67). Variations in reduced iron in porewater seemed to influence variations in trace element concentration. Cumulative arsenic concentration was 87.0 μg l⁻¹ (0.00% Fh), 71.4 μg l⁻¹ (0.05% Fh), and 30.4 μg l⁻¹ (0.10% Fh). For respective cumulative uranium concentrations, we observed 64.3 μg l⁻¹ (0.00% Fh), 50.6 μg l⁻¹ (0.05% Fh), and 42.2 μg l⁻¹ (0.10% Fh). For all systems through all sampling days, the Fe²⁺ in porewater correlated significantly with arsenic (r=0.87,p<0.01). The oxidized arsenic species, arsenate, concentration in porewater (Table 1) followed a pattern opposite to Fe′. The co-occurrence of reduced iron and arsenic species suggests iron reduction controls arsenic mobilization in porewater.

TABLE 1
Shows experimental arsenate concentration compared to aqueous speciation model predicted values
in day 30, 60, and 90 for three Fh enriched systems

| | Sampling | | | | | |
|---|---|---|---|---|---|---|
| | 0.00% w/w Fh | | | | | |
| | Experiment | | 0.05% w/w Fh | | 0.10% w/w Fh | |
| Day | mol L⁻¹ | Model | Experiment | Model | Experiment | Model |
| Day 30 | 2.6 * 10⁻⁷ | 2.3 * 10⁻⁷ | 1.9 * 10⁻⁷ | 2.2 * 10⁻⁷ | 1.3 * 10⁻⁷ | 1.6 * 10⁻⁷ |
| Day 60 | 6.1 * 10⁻⁷ | 5.5 * 10⁻⁷ | 5.2 * 10⁻⁷ | 5.5 * 10⁻⁷ | 1.8 * 10⁻⁷ | 1.9 * 10⁻⁷ |
| Day 90 | 1.9 * 10⁻⁷ | 1.7 * 10⁻⁷ | 9.7 * 10⁻⁸ | 1.0 * 10⁻⁷ | 7.6 * 10⁻⁸ | 7.7 * 10⁻⁸ |

Thermodynamic modeling of the porewater indicated divergent geochemical processes for arsenic and uranium at the root zone-soil-porewater interface. The model predicted reduced iron and arsenate concentrations were similar to experimental values (Tables 1 and 2). The model suggests U(VI) as the primary form of uranium at Day 30. In contrast, calcium bound U(VI) carbonate complex and reduced U(IV) species are thermodynamically favored as the experiment progressed. The primary species of arsenic predicted by the model was HAsO₄²⁻, which may be bound to added Fh. The model predicted a higher saturation index of Fh in amended soils, indicating Fh's occurrence in the porewater, which is expected due to the nanosize. At Day 60, Fh's saturation index decreased in all three systems and became negative in 0.00% and 0.05% Fh systems. Fh's saturation index increased at Day 90, and values became positive in 0.00% and 0.05% Fh systems. Variation in Fh saturation index suggest that both dissolution and formation of Fh nanomineral occurs even under unsaturated conditions.

TABLE 2
Shows experimental Fe²⁺ concentration compared to aqueous speciation model predicted values in
day 30, 60, and 90 for three Fh enriched systems

| | Sampling | | | | | |
|---|---|---|---|---|---|---|
| | 0.00% w/w Fh | | | | | |
| | Experiment | | 0.05% w/w Fh | | 0.10% w/w Fh | |
| Day | mol L⁻¹ | Model | Experiment | Model | Experiment | Model |
| Day 30 | 2.1 * 10⁻⁶ | 2.2 * 10⁻⁶ | 2.0 * 10⁻⁶ | 1.8 * 10⁻⁶ | 1.5 * 10⁻⁶ | 1.5 * 10⁻⁶ |
| Day 60 | 7.9 * 10⁻⁶ | 8.1 * 10⁻⁶ | 6.2 * 10⁻⁶ | 6.1 * 10⁻⁶ | 2.2 * 10⁻⁶ | 2.1 * 10⁻⁶ |
| Day 90 | 4.8 * 10⁻⁷ | 5.1 * 10⁻⁷ | 9.3 * 10⁻⁷ | 8.7 * 10⁻⁷ | 8.6 * 10⁻⁷ | 8.4 * 10⁻⁷ |

The observed and model-predicted porewater elemental concentration indicates the critical role of elevated Fh-levels in the soil. The availability of hydroxyl surfaces from added Fh can potentially bind Fe′, and decrease Fe²⁺ concentrations in porewater of Fh-enriched systems. The presence of elevated Fh can impact trace contaminant mobility, and potentially lowers trace element concentration in porewater of Fh-enriched soils. Dissolution of iron-containing mineral or release of adsorbed Fe²⁺ may also contribute to porewater Fe′. Release of bound Fe²⁺ and iron is plausible, as form of arsenic observed in porewater samples is primarily oxidized, which was well supported by the model. The model also predicted oxidized uranium in porewater, as primary form at the initial stage of the experiment, indicating iron (or reduced iron) may be coming from dissolution processes. However, the rise in Fe²⁺ and reduced arsenic concentration at Day 60 and the subsequent decrease at Day 90 suggest there can be active redox processes in the anoxic microsites of unsaturated soil. The formation of anoxic microsites is also evident from the pattern of observed porewater uranium concentration and model-predicted species. Porewater uranium was highest at Day 30, as uranium is most mobile in its oxidized form. In contrast to arsenic, lower porewater uranium concentrations occurred at the later stage and may reflect the conversion of highly soluble U(VI) to sparingly soluble U(IV) within the localized redox sites. Along with localized anoxic microsites, release of dissolved Fe′, can explain occurrence of reduced species of iron and arsenic in three Fh-systems irrespective of iron uptake mechanism of maize.

Root exudates, organic acids released by growing roots, are utilized to fulfill crop nutrient demand and also result in increased porewater DOC. Root exudate-mediated mineral dissolution processes might also affect the mobility of trace elements in the rhizosphere. In all systems, maximum DOC concentrations were found at Day 60, pointing towards the influence of exudates from growing roots on porewater DOC (FIG. 1B). Furthermore, porewater DOC in control was significantly (p<0.01) higher compared to Fh-enriched soils. Fh enrichment resulted in reduced porewater DOC, most likely due to increased adsorption of dissolved organic moieties on Fh surfaces. Strong positive correlations between overall porewater DOC and overall porewater nitrite (r=0.67, p<0.01), arsenic (r=0.85, p<0.01), arsenite (r=0.73, p<0.01), and Fe²⁺ (r=0.67, p<0.01), and a negative correlation with uranium (r=−0.62, p<0.01) across all treatments and sampling dates, suggests tightly coupled redox cycles in the rhizosphere. The release of DOC from roots can also influence microbial redox processes. Along with transiently saturated soil conditions, DOC release can support development of localized anoxic microsites in unsaturated soil.

Dissolved ammonia, nitrate, nitrite, and orthophosphate concentrations in porewater at three sampling events are presented in FIG. 1B. Nitrate concentrations differed between the different Fh-systems on Day 30 and Day 60, with significantly (p<0.01) lower nitrate loss via porewater in the Fh-enriched systems. The lower nitrate loss (˜30% for 0.05% Fh and −48% for 0.10% Fh) in Fh-enriched soils can promote better nitrate utilization, otherwise prone to leaching, and is readily transported with porewater. Like nitrate, porewater orthophosphate (significant, p<0.01), nitrite, and ammonia were lower in Fh-enriched systems. These results indicate that Fh-enriched soils will have better nutrient retention, which may promote plant growth.

### Example 8—Influence on Crop Health and Trace Contaminant Uptake

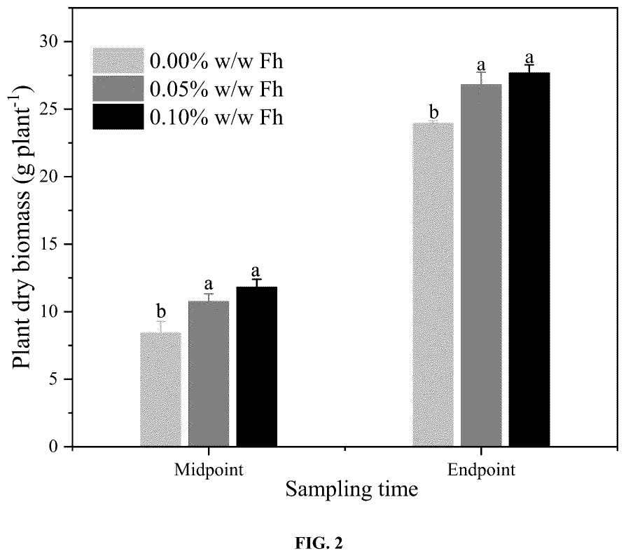

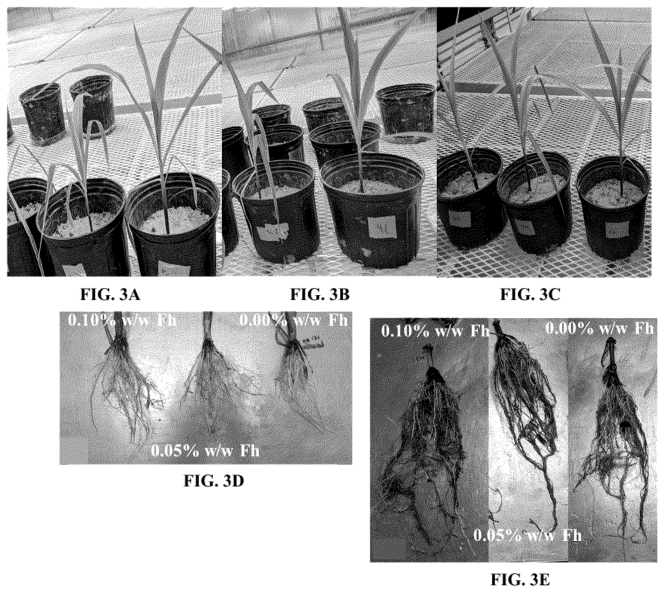

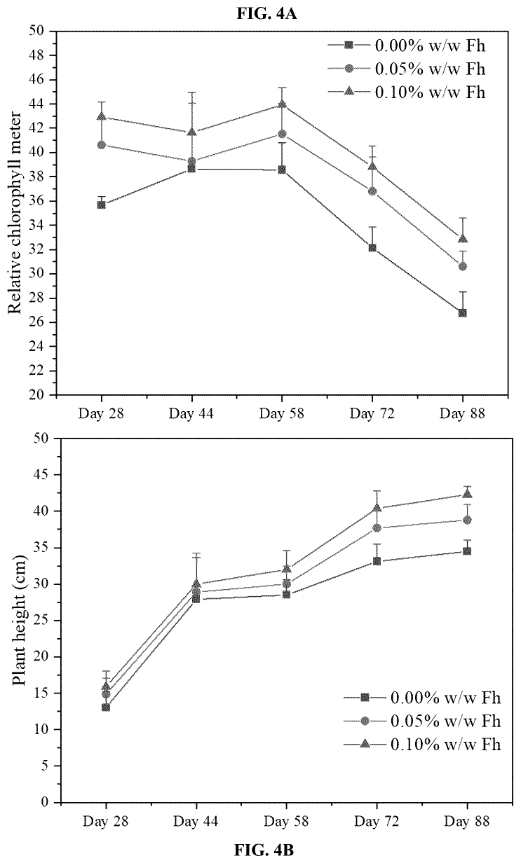

Retention of nutrients in Fh-enriched soils resulted in better plant growth, as observed from dry biomass at two harvesting events, Day 45 (midpoint) and 105 (endpoint). Fh-enriched systems had significantly (p<0.01) higher biomass, ˜27% higher for 0.05% Fh and ˜40% higher for 0.10% Fh at midpoint, and ˜12% (0.05% Fh) and ˜15% (0.10% Fh) higher at endpoint compared to control (FIG. 2). Fh enrichment provided conditions for better root growth than control and plants did not present signs of iron toxicity (FIG. 3). Iron deficiency (Mariotti et al., 1996, Remote Sens. Environ. 58:282-8; O'Rourke et al., 2007, BMC Genomics 8:476) was not observed in control plants (FIG. 3). Improved crop health indices reveal that nutrients retained in Fh-enriched soils are accessible to the plants. Improved plant growth is also indicated in the other plant health indices, including plant relative chlorophyll content and plant height, which were higher in crops from Fh-enriched soils than control (FIG. 4).

Interference to phosphorus plant availability from Fh addition has been previously reported. In contrast, the plants from Fh-enriched soils in this study presented comparable phosphorus content as in control. At midpoint, phosphorus was 2050±225 μg g⁻¹ for 0.10% Fh, 2075±423 μg g⁻¹ for 0.05% Fh, and 2104±108 μg g⁻¹ for 0.00% Fh. At endpoint, phosphorus content in Fh-enriched soils were 2219±767 μg g⁻¹ for 0.10% Fh, 2144±221 μg for 0.05% Fh, and 2253±835 μg g⁻¹ for 0.00% Fh, and the differences were insignificant. The mature grains/kernels also had similar phosphorus in Fh-enriched systems (3127±186 μg g⁻¹ for 0.10% Fh and 3047±497 μg g⁻¹ for 0.05% Fh) and control (3099±828 μg g⁻¹).

The concentration of phosphorus in the present study was comparable to field studies, where phosphorus was not supplied externally. The average grain phosphorus concentration in three-year study was found to be 2933±153 μg g⁻¹. Further, in the present study phosphorus was lost during the porewater collection, and was not externally replenished, which may be the reason of lower phosphorus at the midpoint plant samples. However, the phosphorus values of the midpoint maize plant tissue samples were close to the three-year field study by Gagnon et al. (2020, Eur. J. Agron., 120:126147), where no phosphorus was externally applied.

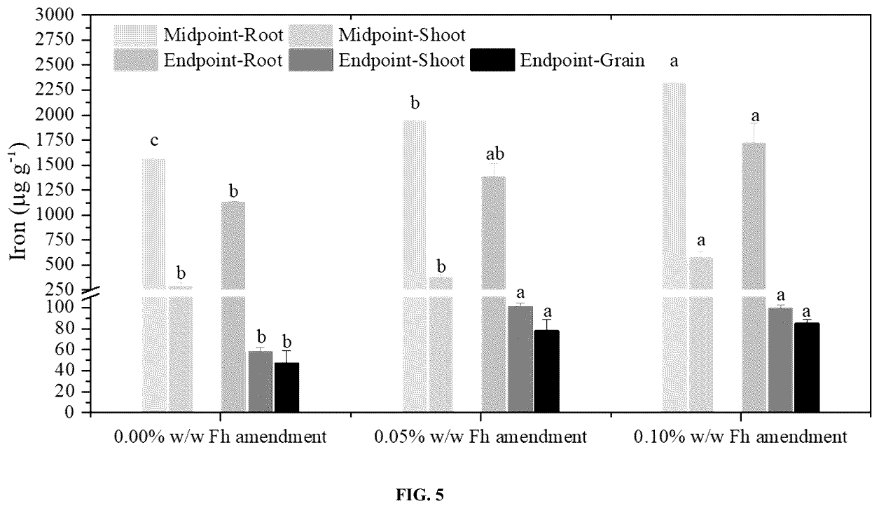

Notably, iron content in the roots and shoots was significantly (p<0.01) higher at the midpoint in Fh-enriched systems than in control (FIG. 5). Higher Fh resulted in higher iron in roots with 1568±88 μg g⁻¹ (0.00% Fh), 1956±60 μg g⁻¹ (0.05% Fh), and 2325±128 μg g⁻¹ (0.10% Fh), and in shoots with 287±37 μg g⁻¹ (0.00% Fh), 377±24 μg g⁻¹ (0.05% Fh) and 575±66 μg g⁻¹ (0.10% Fh). At the endpoint, crops from Fh-enriched soils had significantly (p<0.01) higher iron compared to control; however, iron concentrations in 0.05% and 0.10% Fh systems were similar. Roots at endpoint contained 1134±10 μg g⁻¹ (0.00% Fh), 1382±131 g⁻¹ (0.05% Fh) and 1724±197 μg g⁻¹ (0.10% Fh) and shoots contained 5.28±3.8 μg g⁻¹ (0.00% Fh), 100.9±3.3 μg g⁻¹ (0.05% Fh) and 99.6±2.4 μg g⁻¹ (0.10% Fh). The kernels from Fh-enriched soils contained higher iron compared to control, which were 47.2±11.6 μg g⁻¹ (0.00% Fh), 78.2±10.7 μg g⁻¹ (0.05% Fh), and 85.2±3.0 μg g⁻¹ (0.10% Fh). The data suggests iron uptake and translocation by crops may reach a threshold, and with increasing soil Fh concentration, crops may downregulate uptake mechanisms to prevent iron toxicity. This iron uptake regulation is known to occur in maize and explains similar crop iron concentrations among Fh-enriched systems (FIG. 5).

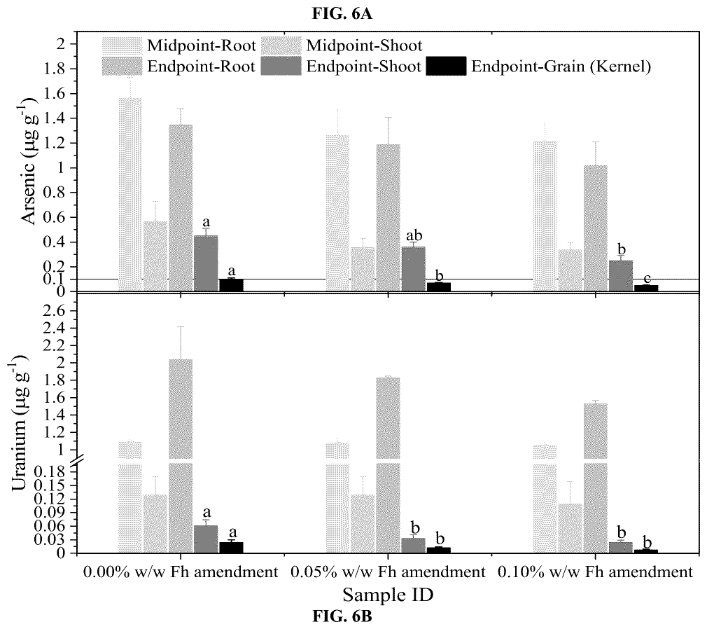

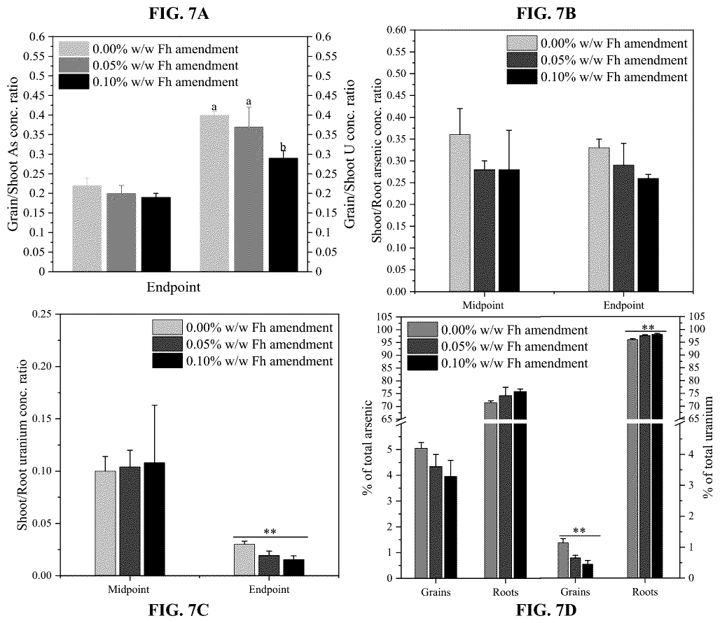

Compared to control, different crop tissues from Fh-enriched soils had lower concentrations of arsenic and uranium (FIG. 6). The amount of arsenic present in shoot and grain at the endpoint was significantly (p<0.01) lower for Fh-enriched systems compared to control (FIG. 6A). Arsenic in kernels was found to reach 0.1 μg g⁻¹ in the control soil, which is the Food and Drug Administration (FDA) suggested limit for arsenic content in food grains. Arsenic and uranium uptake in maize grown in the control soil was comparable with previous studies. Uranium concentrations in shoot and grain were significantly (p<0.01) lower in endpoint crops from Fh-enriched systems than in control (FIG. 6B). In addition to lowering trace element uptake, Fh soil amendment seems to lower translocation of arsenic and uranium from shoot to grain (FIG. 7A) and root to shoot (FIG. 7B, 7C). The highest percentage of total arsenic and uranium was concentrated in the roots (FIG. 7D). Interestingly, at the endpoint, roots in Fh-enriched soils contained a higher percentage of arsenic and uranium (significant, p<0.01) than control (FIG. 7D).

Uranium concentrations in shoot (0.00% Fh=0.061±0.013 μg g⁻¹; 0.05% Fh=0.033±0.008 μg g⁻¹; 0.10% Fh=0.024±0.005 μg g⁻¹) and grain (0.00% Fh=0.024±0.006 μg g⁻¹; 0.05% Fh=0.012±0.002 μg g⁻¹; 0.10% Fh=0.007±0.002 μg g⁻¹) were significantly (p<0.01) lower in endpoint crops from Fh-enriched systems than in control. The amount of uranium in shoot and grain was lower than arsenic due to low uranium mobility, as predicted by the model. Translocation of uranium from shoot to grain was higher than arsenic. However, elevated Fh significantly (p<0.01) lowered the translocation rate (FIG. 7A). Uranium translocation from root to shoot was lower than arsenic. The presence of Fh may have further reduced this translocation (FIG. 7A-7C). The lower concentration of trace elements in the kernels from Fh-enriched systems will help lower trace element concentration in the downstream food products and may protect human health as these contaminants are known for their toxicity. Further, increased iron concentration in kernels of Fh-enriched soil can aid in iron fortification in final products.

The bioaccumulation factor (BF) for arsenic was 1.0 (0.00% Fh), 0.8 (0.05% Fh), and 0.7 (0.10% Fh); and for uranium, 1.2 (0.00% Fh), 1.2 (0.05% Fh), and 1.2 (0.10% Fh) at midpoint. At the endpoint, the BCF was 0.7 (0.00% Fh), 0.6 (0.05% Fh), and 0.5 (0.10% Fh) for arsenic; and 1.5 (0.00% Fh), 1.3 (0.05% Fh), and 1.2 (0.10% Fh) for uranium. The BF values at midpoint and reduction of translocation factor at endpoint suggests major uptake of trace contaminants occurred at the initial growth stage.

Higher uptake of trace contaminants at midpoint, specifically arsenic, seems to be influenced by elevated porewater Fe²⁺. In Graminaceous plants such as maize, the primary iron uptake mechanism is chelation, not reduction. However, maize can have a combined iron uptake mechanism where uptake can occur by chelation and by iron reduction pathway, especially under iron-deficient conditions. Crop demand-driven iron uptake, coupled with higher availability of readily accessible iron in Fh-enriched soil, likely will utilize the chelation pathway. However, under conditions of low plant-available iron, such as in control soil, both uptake mechanisms are possible. The dual uptake mechanisms of maize can explain elevated porewater Fe²⁺ and reduced arsenic in control compared to Fh-enriched systems. The combined effect of matching crop iron demand by both pathways and presence of anoxic microsites can explain a higher concentration of trace elements in the control crops than Fh-enriched systems. It seems evident that Fh's addition to unsaturated soils is beneficial to plants and very likely plays a vital role in the geochemistry at the rhizosphere.

### Example 9—Key Aspects of Ferrihydrite Enrichment in the Rhizosphere Soil

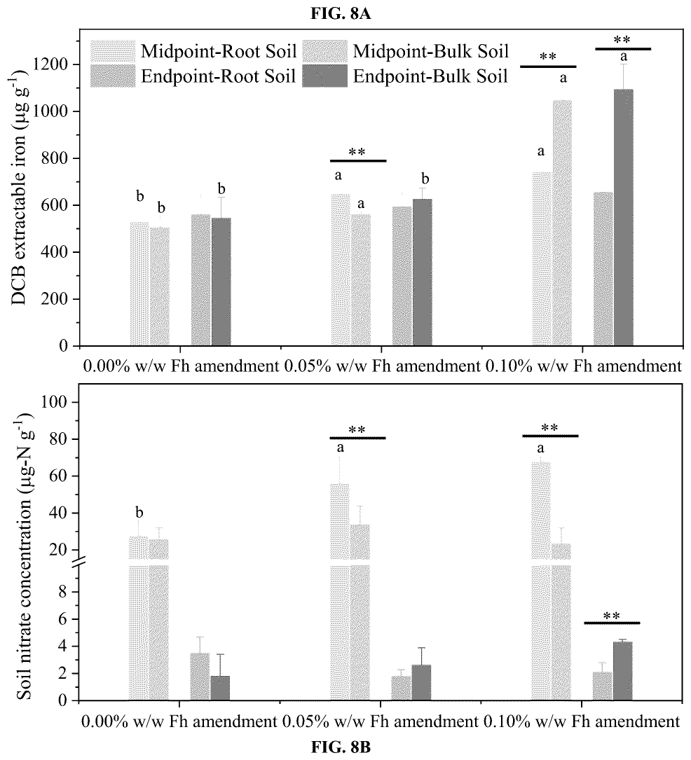

The DCB extractable iron concentration in the three soils on Day 0 were 614±56, 822±68, and 1125±63 μg g⁻¹ for control, 0.05%, and 0.10% Fh, respectively. The low variability of DCB extractable iron at Day 0 suggests homogeneous Fh distribution in the top 5 cm soil. It was expected that Fh added to the soil will be easily accessible to the plants and preferentially used to fulfill crop iron demand, which is indicated by higher crop iron concentration in Fh-enriched systems (FIG. 5). Further, it was anticipated that the bulk soil composition would not be influenced by rhizosphere processes and should have a similar or slightly lower concentration, if Fh transformation occurs, of DCB extractable iron at mid and endpoint, than Day 0. DCB extractable iron in bulk soil followed the expected pattern in 0.10% Fh at mid and endpoints (i.e., Day 45 and 105) (FIG. 8A). The predicted pattern was observed in the 0.05% Fh at the endpoint. However, DCB extractable iron was higher in rhizosphere soil of control (at mid and endpoint) and 0.05% Fh (at midpoint) (FIG. 8A). In the 0.05% Fh, the difference in DCB extractable iron between rhizosphere and bulk soil was significantly (p<0.01) different.

Iron demand in maize is higher in the initial growth stage, which may be the reason for higher DCB extractable iron in rhizosphere soils of control and 0.05% Fh (DCB extractable iron, control: 530±56 μg g⁻¹, 0.05% Fh: 651±28 μg g⁻¹, 0.10% Fh: 744±16 μg g⁻¹). The elevated concentration of DCB extractable iron in control and 0.05% Fh systems may indicate preferential extractable iron enrichment at the rhizosphere tied to the crop iron demand, which is regulated by maize roots as per soil iron availability. A similar preferential iron enrichment mechanism may occur in the rhizosphere of the 0.10% Fh system. However, given the elevated levels of externally supplied Fh, as soon as the crop iron demand is fulfilled, crops downregulate iron uptake. The downregulation of iron uptake may be a reason for low or no extractable iron enrichment at the rhizosphere soil of 0.10% Fh. The model predicted Fh's saturation indices at Day 90 porewater suggested fresh Fh precipitation, which explains higher DCB extractable iron in control at the endpoint. Crops typically require less iron at later growth stages, which may be why, at the endpoint, DCB extractable iron in rhizosphere soil of Fh-enriched systems does not decrease much from the midpoint. Colloidal particles, such as Fh, can be transported along with the mass flow in the soil, as per plant water demand. The concentration of total (average of root and bulk soil) arsenic and uranium slightly increased by the end of the experiment (Table 3), which may be within the variability of the soil. Further, as the experiment progressed, Fh's higher availability in amended soil may bound arsenic and uranium coming from irrigation water within the soil and make them less available to the crops or leaching to groundwater.

TABLE 3
Total soil arsenic and uranium concentration at
the mid and endpoint of the experiment

| | Midpoint | | | |
|---|---|---|---|---|
| | Arsenic | | | |
| Fh | Mean ± S.D. | Endpoint | Midpoint | Endpoint |
| Enrichment | μg g⁻¹ | Arsenic | Uranium | Uranium |
| 0.00% w/w Fh | 2.24 ± 0.10 | 2.85 ± 0.24 | 1.10 ± 0.04 | 1.44 ± 0.30 |
| 0.05% w/w Fh | 2.26 ± 0.16 | 2.85 ± 0.11 | 1.05 ± 0.02 | 1.40 ± 0.18 |
| 0.10% w/w Fh | 2.28 ± 0.41 | 2.82 ± 0.43 | 1.17 ± 0.20 | 1.49 ± 0.36 |

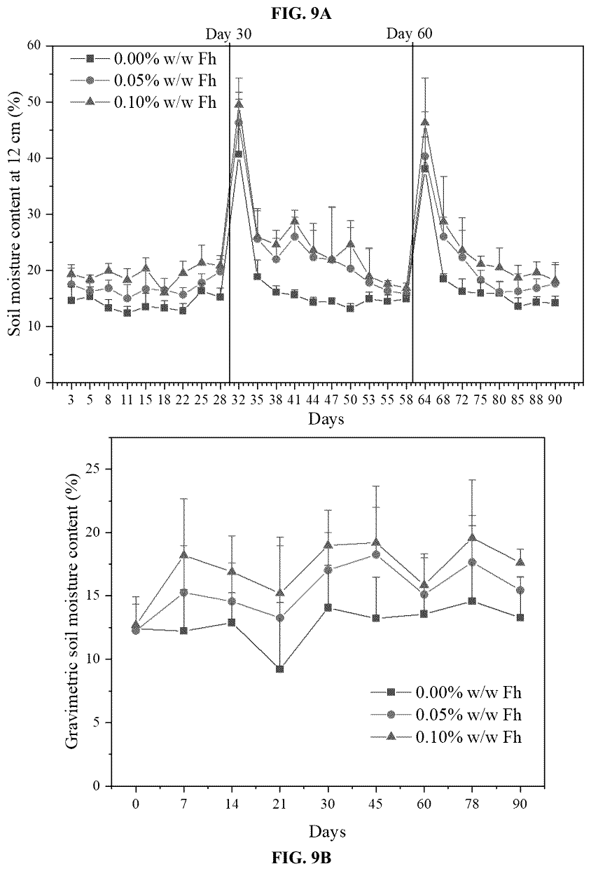

Further, the Fh amendment aided in nutrient use efficiency by the preferential distribution of nutrients in the soil, another key feature for promoting plant growth. At the midpoint when nitrate demand was high, rhizosphere soil of the Fh-enriched system had significantly (p<0.01) higher nitrate concentration than control (FIG. 8B). The 0.10% Fh treatment had the highest nitrate concentration (67.9±3.0 μg-N g⁻¹) followed by 0.05% Fh (56.2±4.5 μg-N g⁻¹), and control (27.7±8.8 μg-N g⁻¹). The bulk soil nitrate concentration was comparable to rhizosphere soil (25.7±6.4 μg-N g⁻¹) in control, but in the Fh-enriched systems, bulk soil had significantly lower nitrate (33.9±10.1 μg-N g⁻¹, 0.05% Fh; 23.4±8.8 μg-N g⁻¹, 0.10% Fh). Maize nitrogen demand is highest during the initial growth stage, and a higher nitrate level at rhizosphere would improve crop health. At the endpoint, 0.10% Fh showed significantly (p<0.01) lower nitrate concentration in rhizosphere soil than the bulk. This lower nitrate in rhizosphere can be due to better utilization of nitrate by the crops. The lower concentrations of nitrate in porewater of Fh-enriched soils indicated better nitrate retention in the soil, and soil nitrate data affirms that. The distribution of soil nitrate indicates that Fh enrichment may facilitate plant nitrate use efficiency as reflected by relative chlorophyll content. Phosphorous concentrations in soil were similar between the root and bulk soil. Soil water content, a critical component for plant growth, was positively influenced by Fh addition. Throughout the experiment, Fh-enriched soils had significantly (p<0.01) higher water retention. Average gravimetric soil water content (FIG. 9) was 12.8±1.5% for the control, 15.4±1.9% for 0.05% Fh, and 17.1±2.2% for 0.10% Fh. The unsatisfied bonds on Fh's surface may help retain water molecules efficiently and increase the soil water content.

Nitrate can bind to Fh by monodentate mononuclear surface complexation through normal or charge-assisted hydrogen bonding. The adsorption of nitrate on fresh Fh can lower nitrate loss and make them more available at the rhizosphere during preferential movement of Fh towards the rhizosphere. High iron demand at the midpoint explains the higher nitrate concentration at the rhizosphere, which aided in plant growth. Fh is known to interact with dissolved phosphate, and iron oxides present in soil from the beginning could have already adsorbed phosphate, and phosphate was not supplied externally in the experiment. Low doses of added Fh were not found to affect phosphorus plant availability as indicated by phosphorus concentration in crops. The enhanced availability of soil water and efficient nutrient distribution positively influenced plant growth in Fh-enriched soils.

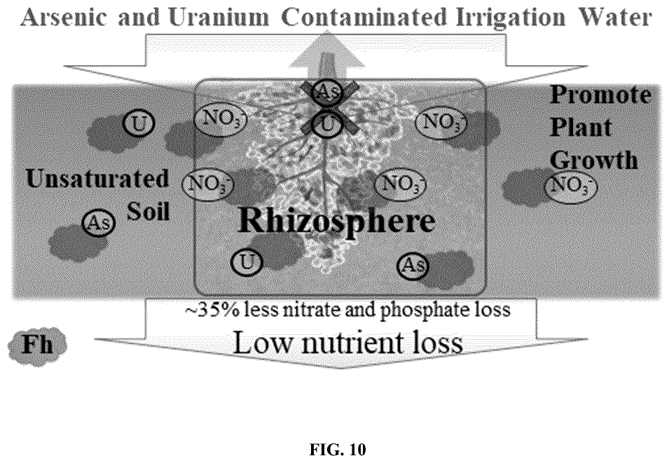

The positive influence on plant nutrient availability and trace contaminants immobilization is a consequence of elevated Fh nanomineral in the unsaturated soil (FIG. 10). Our results highlight how the dynamics of reactive iron minerals influenced by crop iron demand, and flow of porewater in irrigated soil, can control the accessibility of nutrients and lower bioavailability of trace elements. The percolation of irrigation water through the soil pores and subsequent water movement to the roots seem to promote movement of colloidal Fh. Our data showed that Fh in the root zone-soil-porewater interface is an essential factor controlling nutrient and trace element bioavailability in transiently saturated irrigated soils. Anoxic microsites in the root zone-soil-porewater interface of unsaturated soil may regulate important redox-sensitive reactions. Further, the availability of labile iron mineral at the vicinity of these microsites seems to play a critical role in controlling geochemical reactions favoring plant growth and limiting trace contaminants mobility.

The study contributes to a better understanding of the critical role that iron nanominerals play in unsaturated soil and provides a framework for nanotechnology-based soil amendment.

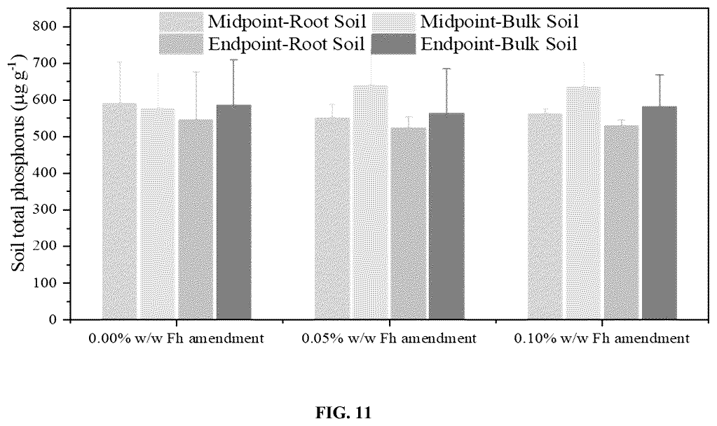

Nano-iron soil amendment improved nutrient and moisture availability to crops grown under unsaturated conditions. The addition of low doses of iron nanominerals to soils under sprinkler or subsurface drip and even flooded irrigation similar to rice can have significant implications for the accessibility of nutrients, including iron, and control trace element mobilization. The low doses of Fh did not influence soil phosphorus availability (FIG. 11), and phosphorus deficiency was not observed in the crops. Fh amendments may also beneficially manage carbon and nitrogen biogeochemical cycles at the rhizosphere. These critical processes controlled by iron nanominerals under unsaturated and saturated conditions can help regulate nutrients and contaminants lost from the root zone, which infiltrate into the groundwater. Finally, the role of natural and synthetic iron nanominerals under agricultural soils seems to be crucial for improving water and food safety and security.

We also propose that these groups of naturally occurring iron and other elemental (aluminum, silicon, manganese) nanominerals can be mixed with other soil amendments such as biochar, ground wood chips, or wheat straw, to improve water and nutrient retention. Naturally occurring, synthetically produced nanominerals can easily be functionalized with macro and micronutrients to be used as custom soil amendments. For example, Fh can be co-precipitated with nitrate, phosphate or a cocktail of important nutrients which can be tailor-made to specific crop needs and added to soil as a seed mixture prior to seeding. Application of these nanominerals through seed treatment or as an emulsion spray through chemigation, has great potential for improving soil health and reducing agricultural water footprint. Synthetically produced, natural nanominerals may be used to improve crop production via current agricultural technologies.

### Example 10—Ferrihydrite Impact on Paddy Soils

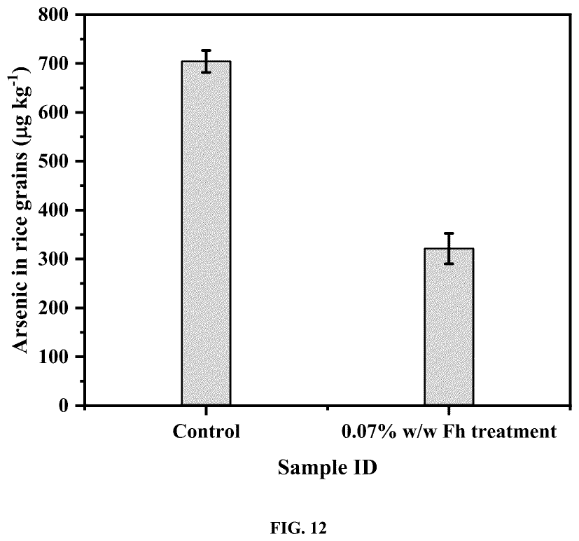

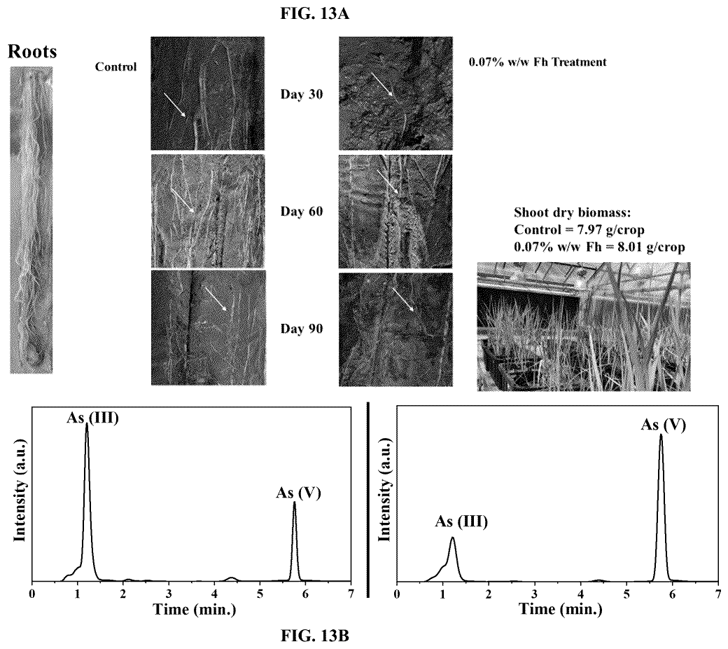

We further tested the efficacy of the iron nanoamendment under flooded conditions and growing rice. Arsenic present in rice grains is one of the major pathway of arsenic exposure in humans. Flooded soils, which is prevalent to rice, has been known to foster arsenic uptake, but iron plaque formation also is known to prevent arsenic bioconcentration factor. The aim of adding Fh is to promote this iron plaque formation in rice roots by application of synthetic 2-line ferrihydrite in the soil under flooded condition. In a greenhouse experiment, Sabharaj rice variety (n=147) was grown in paddy field soil from Arkansas. One set of paddy soil received 0.07% w/w ferrihydrite treatment and other set is control (n=5 tubs, 49 crops for each). Arsenic(V) (50 ng/ml) spiked tap water was used to maintain flooded condition. Interestingly, other than the control, reduced iron was not observed in the ferrihydrite-treated system irrigation water. Although only arsenate was spiked into the irrigation water, control tubs water showed higher conversion to arsenite (60±1%) compared to ferrihydrite treated tubs (32±0.4%). Arsenite is more mobile than arsenate and is known to be taken up more easily by rice. We postulate that enhanced availability of ferrihydrite layers in the root preferentially immobilizes added arsenate and also makes less arsenate available for reduction to arsenite. This reduction in arsenite concentration available in flooded water limits uptake of arsenic into rice. We see similar benefits in rice and further reduction of arsenic uptake, specifically inorganic arsenic, which is most toxic and carcinogenic to humans, in the rice grown with the nanoamendment (FIG. 12). As postulated roots clearly show better iron coating or plaque formed under treated systems (FIG. 13A) and irrigation water contained less mobile arsenate (FIG. 13B). The soil amendment was found to create a protective layer in the roots, which prevented uptake of arsenic by the crops. Moreover, the end rice grains also showed a higher quantity of iron, which can act as a direct iron supplement for rice eating population in Asian countries, for example, where major population tends to be iron deficient.

### Example 11—Impact of Ferrihydrite Through On-Farm Trial on Row Crops Under Center Pivot and Dryland Systems

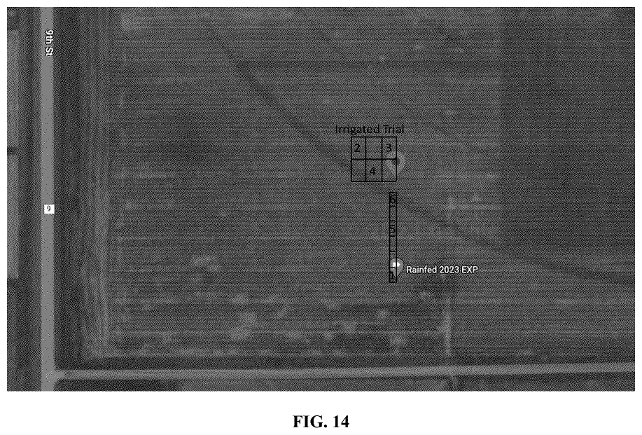

Ongoing field trials are being conducted in eastern Nebraska, where Fh has been applied at 0.05% w/w to topsoil by spraying in two corn fields, one with center-pivot sprinkler irrigation system and another with no irrigation system—dryland system (FIG. 14). Two data points have been collected, which primarily includes crop vegetative states, plant health indices, and soil moisture content. Moisture content in the top 15 cm was measured using a handheld moisture probe (Extech M0750 Soil Moisture Meter, FLIR Commercial Systems Inc., Nashua, NH, USA) (Deng et al., 2015, PLoS One, 10). Health indices of crops were measured—chlorophyll content, was assessed with a chlorophyll meter (SPAD-502, Minolta, Tokyo, Japan) by averaging five readings of the tallest fully collared leaf (Zhang et al., 2009, Commun. Soil Sci. Plant nal., 40:2087-93). Plant height was measured from the soil surface to the arch of the uppermost leaf (Freeman et al., 2007, Agron. J., 99:530-6). In the first sampling event in June under the dryland system, Fh-treated crops showed an appropriate vegetative state, even after acute drought conditions. Crops in control of the dryland system were in the V10 stage, whereas crops under treatment were at the V12 stage. The V12 stage of crops was also observed in the irrigated plots; however, 46% of crops in control were still in the V11 stage under irrigated system. In the early August sampling under Fh-treated dryland system, 100% crops were in the V15 stage, whereas 85% under control were in the V15 stage, and the rest were still in the V14 stage. On the irrigated plots, almost all crops reached the V15 stage; only ˜8% under control were still in the V14 stage. Plant heath indices (Table 4) further signify the impact of Fh treatment under both conditions for corn production. Fh-treated soil shows significantly (p<0.05) better moisture retention under both irrigation systems. The better moisture content of soil helps Fh-treated plots outperform in plant health indices under dryland systems.

TABLE 4
Plant health indices differences between Fh-treated and untreated soil under two
ongoing farm trails covering rainfed and irrigated systems (mean ± standard deviation).

| | Sampling 1 | | | Sampling 2 | | |
|---|---|---|---|---|---|---|
| | | Plant | Soil | | Plant | Soil |
| Field Setting | SPAD | Height (cm) | moisture % | SPAD | Height (cm) | moisture % |
| Center-pivot (Sprinkler) - | 46.6 ± 1.8* | 102.3 ± 9.3 | 30.3 ± 2.1* | 54.9 ± 2.2 | 162.0 ± 3.5 | 43.5 ± 2.3* |
| Control | | | | | | |
| Center-pivot (Sprinkler) - | 52.4 ± 3.5* | 119.7 ± 8.7 | 36.7 ± 0.6* | 55.5 ± 1.6 | 165.3 ± 6.1 | 48.3 ± 0.9* |
| 0.05% w/w Fh | | | | | | |
| Dryland (Rainfed) - Control | 50.4 ± 4 | 99.7 ± 4.7* | 22.7 ± 1.2* | 57.7 ± 3.1* | 146.3 ± 4.9* | 25.4 ± 0.9* |
| Dryland (Rainfed) - 0.05% | 55.1 ± 1.4 | 117.7 ± 7.5* | 29.7 ± 1.5* | 62.7 ± 0.6* | 160.3 ± 3.5* | 28.9 ± 1.2* |
| w/w Fh | | | | | | |

*represents differences are significant (p <0.05) between Fh-treated and control plots within individual irrigation systems.

It is to be understood that, while the methods and compositions of matter have been described herein in conjunction with a number of different aspects, the foregoing description of the various aspects is intended to illustrate and not limit the scope of the methods and compositions of matter. Other aspects, advantages, and modifications are within the scope of the following claims.

Disclosed are methods and compositions that can be used for, can be used in conjunction with, can be used in preparation for, or are products of the disclosed methods and compositions. These and other materials are disclosed herein, and it is understood that combinations, subsets, interactions, groups, etc. of these methods and compositions are disclosed. That is, while specific reference to each various individual and collective combinations and permutations of these compositions and methods may not be explicitly disclosed, each is specifically contemplated and described herein. For example, if a particular composition of matter or a particular method is disclosed and discussed and a number of compositions or methods are discussed, each and every combination and permutation of the compositions and the methods are specifically contemplated unless specifically indicated to the contrary. Likewise, any subset or combination of these is also specifically contemplated and disclosed.

1. A method of improving the growth of plants, comprising:
applying a composition to seeds, to the plants, or to soil in which the plants are growing, wherein the composition comprises ferrihydrite (Fh) or a pharmaceutically acceptable salt thereof.

2. The method of claim 1, wherein the composition is a powder.

3. The method of claim 1, wherein the composition is a liquid.

4. The method of claim 1, wherein the composition is diluted prior to the applying step.

5. The method of claim 1, wherein the composition has a pH of about 6.5.

6. The method of claim 1, wherein the composition further comprises a zinc compound or other macronutrients and/or micronutrients.

7. The method of claim 1, wherein the applying is via irrigation systems.

8. The method of claim 1, wherein the applying is via a spray.

9. The method of claim 1, wherein the applying is via coating seeds.

10. The method of claim 1, wherein the applying occurs more than once in a growing season.

11. The method of claim 1, wherein soil and/or crop iron levels are monitored.

12. The method of claim 1, wherein the Fh is applied at an amount ranging from 0.02% w/w to 0.15% w/w.

13. The method of claim 1, wherein improving growth refers to increasing water retention, improving water availability for plants in arid to semi-arid conditions, and/or reducing water loss under both irrigated and dryland agricultural soil.

14. The method of claim 1, wherein improving growth refers to increasing nitrate retention, improving nitrate availability for plants between fertilizations, improving phosphate and other macro- and micronutrients availability for plants, and/or reducing nitrate leaching.

15. The method of claim 1, wherein improving growth refers to reducing heavy metal bioavailability and/or reducing the bioavailability of uranium and arsenic in plants.

16. The method of claim 1, wherein improving growth refers to reducing heavy metal mobility and/or reducing the leaching of uranium and arsenic to the ground water.

17. The method of claim 1, wherein, after the applying step, the plants exhibit increased biomass, increased root growth, increased plant height, increased relative chlorophyll content, proper vegetative state even under acute drought conditions, and/or improved carbon sequestration post harvest.

18. The method of claim 1, wherein, after the applying step, the plants exhibit lower concentrations of arsenic and uranium and any other geogenic contaminants such as selenium in the (above-ground parts of the) plant and/or increased concentrations of iron in the plant.
